(19) United States
(12) Patent Application Publication
(10) Pub. No.: US 2002/0052788 A1
(43) Pub. Date: May 2, 2002

(54) New-media monetary engine business method

(75) Inventors: Ronald M. Perkes, Novato, CA (US); Jeffrey A. Moss, San Rafael, CA (US)

Correspondence Address: Brian J. McNamara, FOLEY & LARDNER, Washington Harbour, 3000 K Street, N.W., Suite 500, Washington, DC, 20007-5109, US

(73) Assignee: Lumenati, Inc.

(21) Appl. No.: 09/978,589

(22) Filed: Oct. 18, 2001

Related U.S. Application Data
(60) Provisional application No. 60/241,748, filed on Oct. 20, 2000.

(51) Int. Cl. G06F 17/60

(52) U.S. Cl. 705/14; 705/35; 705/39

(57) ABSTRACT

The New-Media Monetary Engine (“NME”) is a collection of methods used in building a monetary exchange through a client server software engine that allows advertisers to promote products and services to targeted consumers and to provide credits and coupons through the monetary exchange to those consumers as an inducement to viewing or sampling advertising or content, then allows that consumer the opportunity to spend or exchange credits and coupons for premium content and selected e-commerce and off-line commerce/advertising. Additional methods include the ability to scale credit use with the quality of service with which the content is delivered, to scale the amount of credit provided based on the level of consumer involvement with the promotional message or content, the ability to display onscreen the current credit and coupon account balances, the ability to bill the customer or the customer's credit card periodically for credits used in excess of credits earned, the ability of a senior family member to limit credit and/or coupon accumulation and use by other family members, the ability to track credits and/or coupons by individual family member or alternatively across family usage, and the ability to share, exchange, or barter credits and/or coupons among family members.

### BACKGROUND OF THE INVENTION

1. Field of the Invention

The present invention relates to a method for e-commerce. In particular, the present invention relates to the use of coupons and/or credits by consumers in an e-commerce environment.

2. Description of the Related Art

The sweeping transformation to digital entertainment is obsoleting analog entertainment systems. The desperately needed infrastructure is woefully inadequate. A confusing assortment of piecemeal solutions fails to add up to what is needed. Worse yet the traditional economic model of advertiser supported TV is fracturing and new economic models for viewing digital media are all over the board, compounding the need for a new media monetary engine that provides a framework for advertisers, and electronic content providers to work together in a quantifiable monetary exchange. Seventy-four million broadband-equipped homes and 90 million digital television-equipped homes in the US are projected by the year 2008 with the majority of those homes having both. The blend of traditional media and newer digital media along with digital storage of traditional media that allows non-linear playback and skipping of traditional advertisements compounds the need to re-intermediate the three way relationship amongst advertisers, consumers and content providers. The New-Media Monetary Engine is a unique and elegant solution that provides all parties a framework for plugging into in the new economy and changing paradigm.

### SUMMARY OF THE INVENTION

1. Digital Credits. A method according to the invention involves the creation of a digital currency (called credits, dollars or a more unique term) to be used in Internet and Interactive TV transactions. Credits are the general form of currency offered to individual users in virtual “accounts” in exchange for viewing ads or promotional content, participating in on and off-line advertising and promotional activities or making purchases of fee based content, products or services from participating retailers, and once accumulated can be spent on selected purchases of fee based content, products or services. Purchases may be either from the sponsor of the currency program, the sponsors of content, or participating retailers. The number of Credits a user receives for content viewing depends on the type of content being viewed, the extent of the viewing and the rate the sponsor of the content is willing to pay for that viewing. The amount of currency a user receives for making purchases of fee based content, products or services depends on the rate that the sponsor of the program, sponsor of content or participating retailer are willing to pay for that transaction.

2. Digital Coupons. The method also includes the creation of digital coupons (“Coupons”), also to be used in the same manner as Digital Credits and accounted for in digital accounts. Coupons are targeted offers, for example, an offer to rent a specific brand of car to those who buy a particular airfare. Coupons may also be offered in exchange for viewing ads or content or making purchases of products or services from participating retailers, and once accumulated can be spent on selected purchases of fee-based content, products or services as discussed above. The sponsor of the program, sponsor of the content being viewed or other Participating Retailers may offer coupons. Coupons can be in many forms, and preferably will have embedded in them links to the offering Retailer's website and be printable for off-line transactions.

3. Digital Account Balance. The digital account is maintained on a central server or servers, is password protected and is accessed over any Appliance. The status of the account can be accessed as desired by a user, or the sponsor of the currency program can initiate transmission. The balance of the account is reflected in a display that shows the number of credits and/or coupons that are available to the user at that particular time. When visible, the balance indicator visibly increases or decreases when transactions are consummated over the Internet, and may be accompanied by advertising for products whose costs can be accommodated by that balance.

Similar to the credit card process, the actual account balance is known only to the user and program sponsor. For instance, a retailer with a product that costs $99.00 can send advertising to anyone with a current account balance or average daily account balance over a selected amount (such as $100.00), but will not know if a targeted account has $100.01 or $9,000.00, and will have no information about the targeted account. The advertising is sent to anyone who the Program Sponsor determines, through profiling techniques, meets that retailers target audience. As additional protection for both the user and retailer, personally identifiable information regarding the account holder is not accessible by the retailer.

The Digital Account Balance can also be viewed in the Detailed Account Status mode, where different views, information and capabilities and information are available depending on the status of the User.

4. Display of Credit Balance. In the present invention, the balance of the digital account is displayed having a “game status” format, i.e. on a display across the bottom, top or side of the screen as selected by the user. Coupons are displayed in alternative ways (such as color or shape differentiation), to make them visible and call them to the attention of the user in an attempt to encourage their use. Details regarding time-dated special offer Coupons are available by going to the individual user's Account Balance page which in turn reveals the type of offer, offer expiration date, and a link to the offeror's website to redeem the coupon. and other information. Alternatively the user can set a reminder to use a coupon before expiration, or the user can be automatically notified of coupons soon to expire. The display shows the name of the credit program, the balance of the digital account reflected in one of multiple ways selected by the user (as a dollar figure, pile of cash, other figure or combination of figures) and the existence of any coupons. The account status display can also accommodate a hyperlink to the user's Detailed Account Information page on the Program Sponsor's website, advertising, content/game/contest notifications and additional items selected by the Program Sponsor. The account balance reflects the reduction or increase in the account simultaneously (as allowed by technology) with the transaction affecting the account balance.

5. Scaling Credits Spent on Content with Quality of Service. In the present invention, content providers and system operators are capable of charging more for specific items, such as high bandwidth, immediate video on demand, and higher resolution versions of a program. Conversely, a method is provided for content providers and system operators are capable of charging less for specific items, such as off-peak video delivery that is in turn cached by at the user's location for delayed playback and lower resolution versions of content.

6. Scaling Credits Earned from Advertisers with Levels of Consumer Involvement. Advertisers and system operators are capable of scaling the Ad Credits based upon the involvement of the user. In the example where the user is deemed by his or her profile to be an ideal candidate for a sports utility vehicle and is presented a screen of SUVs to learn more about, browsing he screen earns the user 10 credit, listening to a pitch gets two credits, going to the website and registering for more information or agreeing to submit the user's profile for follow up notifications earns the user 300 credits, and going to the dealer's lot and taking a test drive gets 5 credits, for example. Buying the vehicle might earn 1000 credits.

7. Tracking Credits by User and by Family and Allowing Barter and Exchange of Credits. Also, credits to the individual family member or household user can be tracked in the present invention. Furthermore, family or household credits can be tracked intra-family, and a senior family member can be given the ability to limit credit use by other family members, either by limiting purchases to credits on hand or restricting the purchases to a certain credit or dollar amount in excess of the credits charged. Credits can be exchanged or bartered amongst family members. Individual users or family members can track their usage statistics.

8. Off-Line Validation. The involvement of Users may extend to off-line activities, which may range form the printing out and mailing in of coupons, off-line use of credits for the purchase of products or services, to a User's physical involvement in off-line activities such as attendance at promotional events or taking a vehicle test drive. Once a User completes the involvement, the Participating Retailer advises the Program Sponsor of the involvement and the number of credits/coupons the User has earned from that involvement. The User's digital account is credited in the same manner as an on-line transaction.

9. Billing. Billing is done on a family or household basis in those instances where total family credits earned are less than credits spent. Billing can be by statement or to the customer's credit card.

### BRIEF DESCRIPTION OF THE DRAWINGS

The invention will become more fully apparent from the following detailed description when read in conjunction with the accompanying drawings with like reference numerals indicating corresponding parts throughout, and wherein:

FIG. 1 is a diagram illustrating a method of signing on for new and existing Users;

FIG. 2 is a diagram illustrating the Application Process;

FIGS. 3 and 3A are a diagrams illustrating the Status Bar;

FIGS. 4 and 4A are diagrams illustrating the Detailed Account Status screen; and

FIG. 5 is a diagram illustrating a Credit/Coupon Accumulation Method.

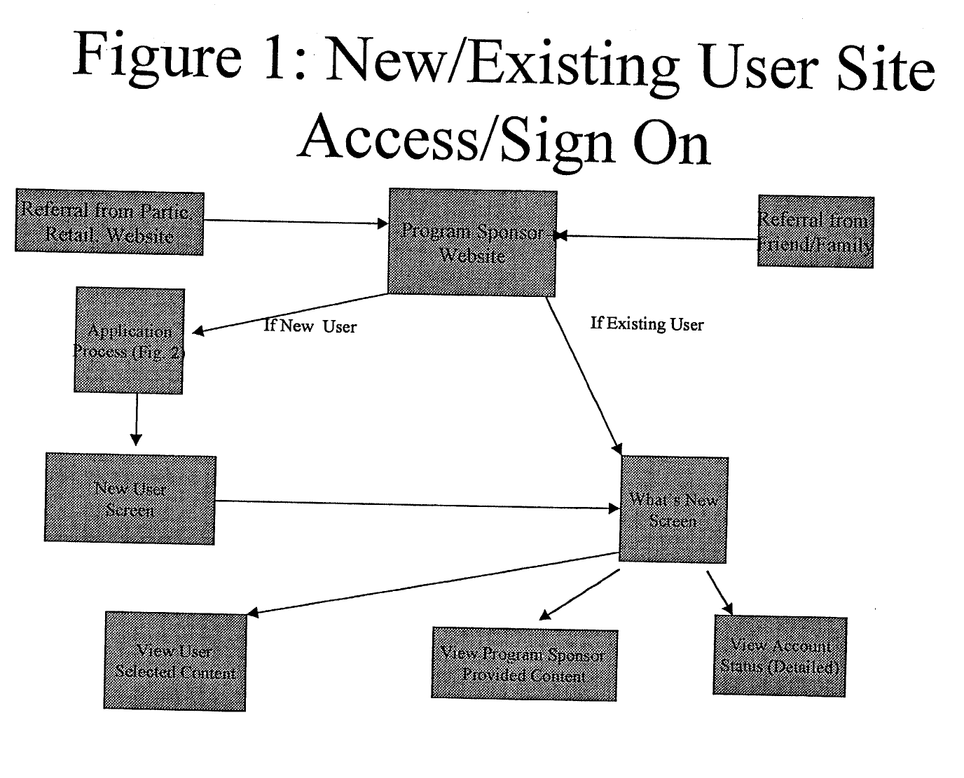

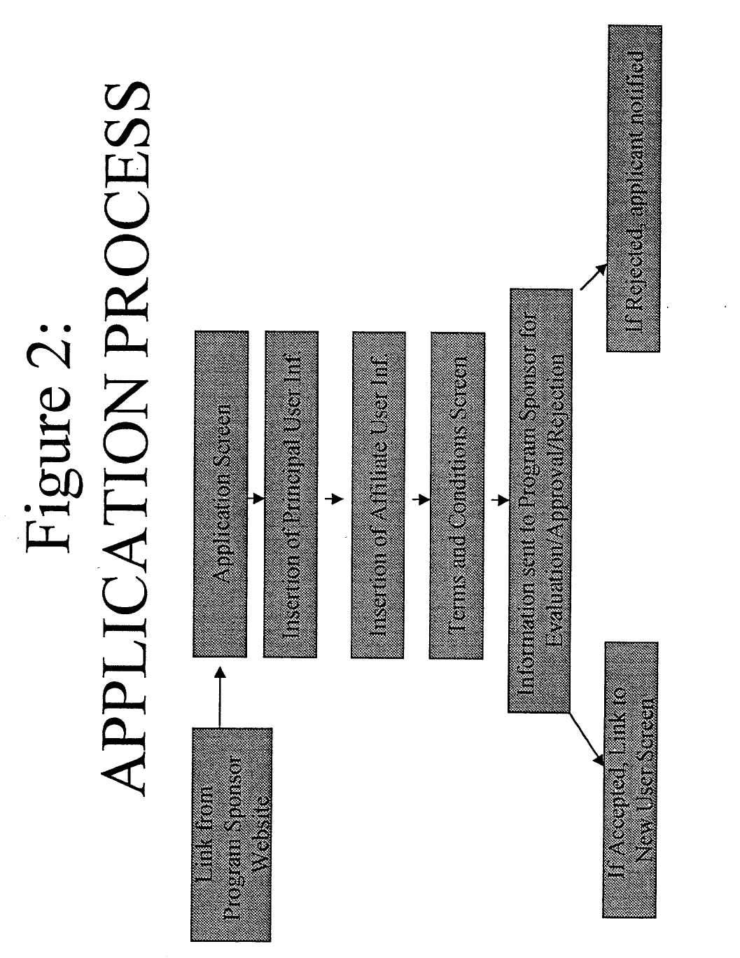

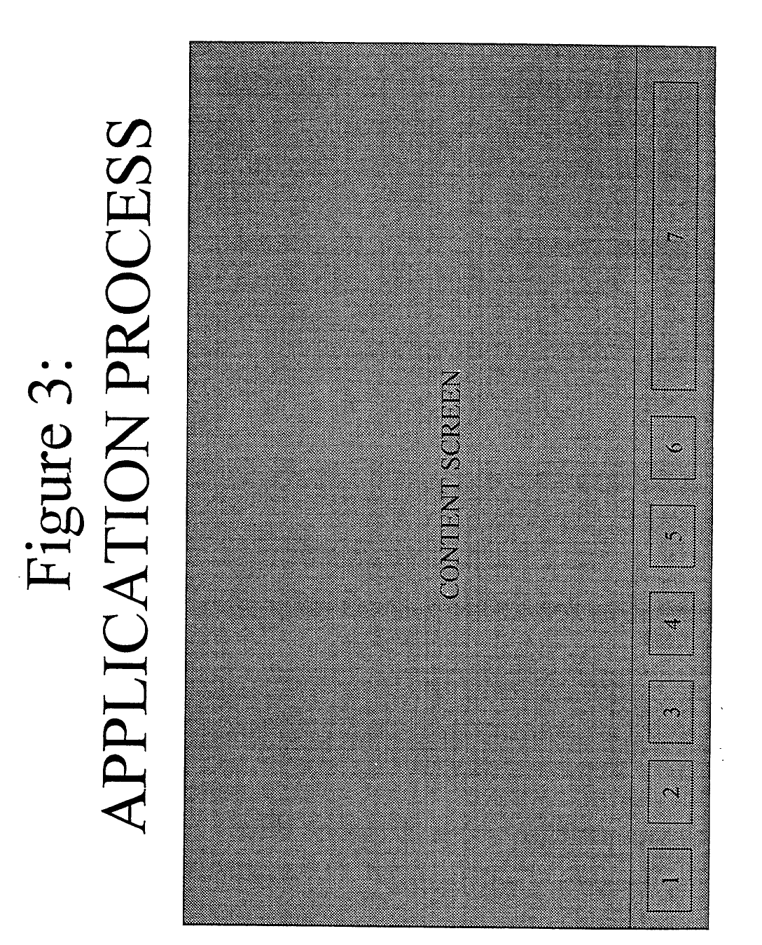

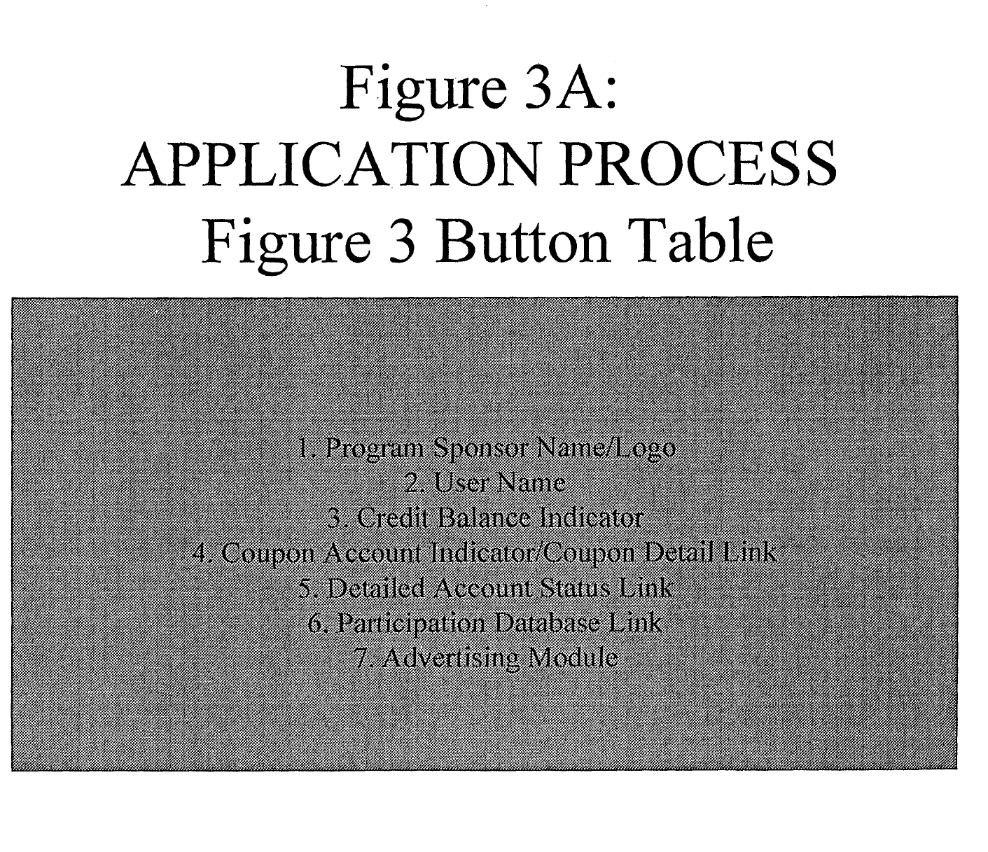

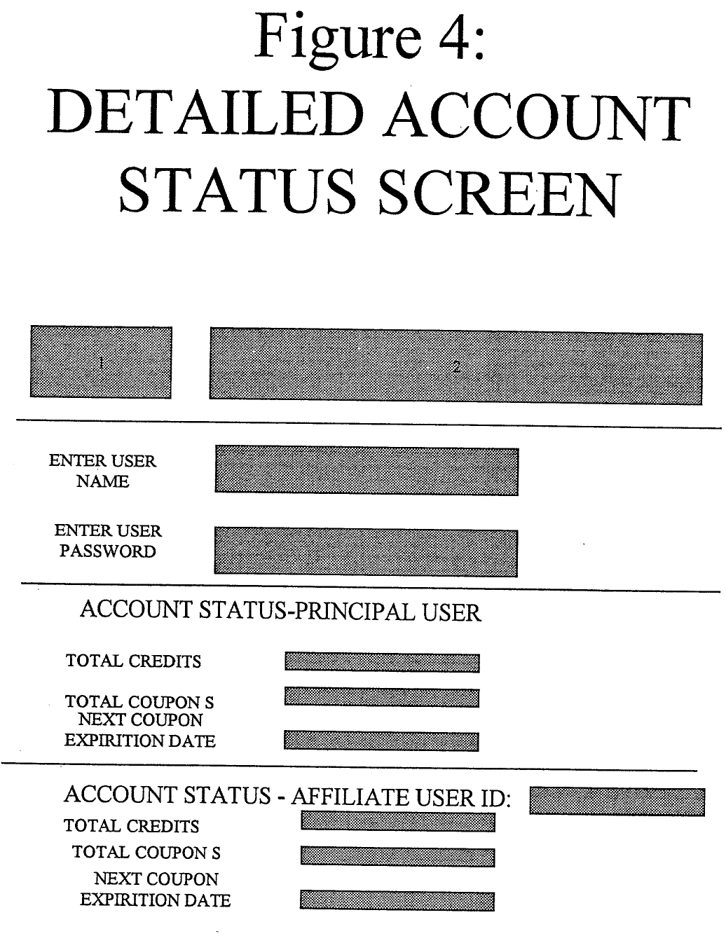

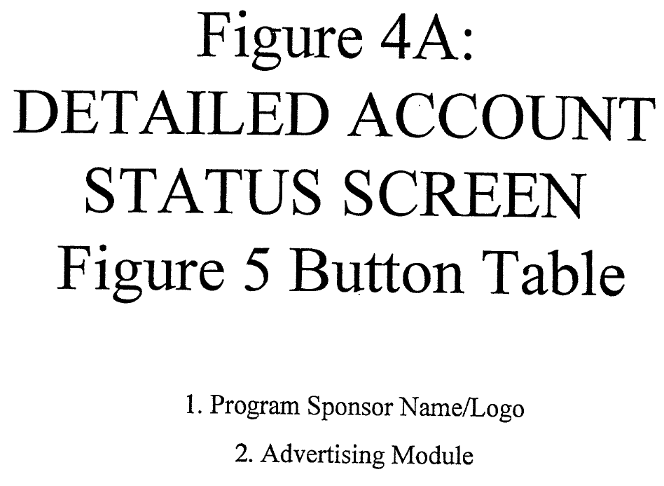

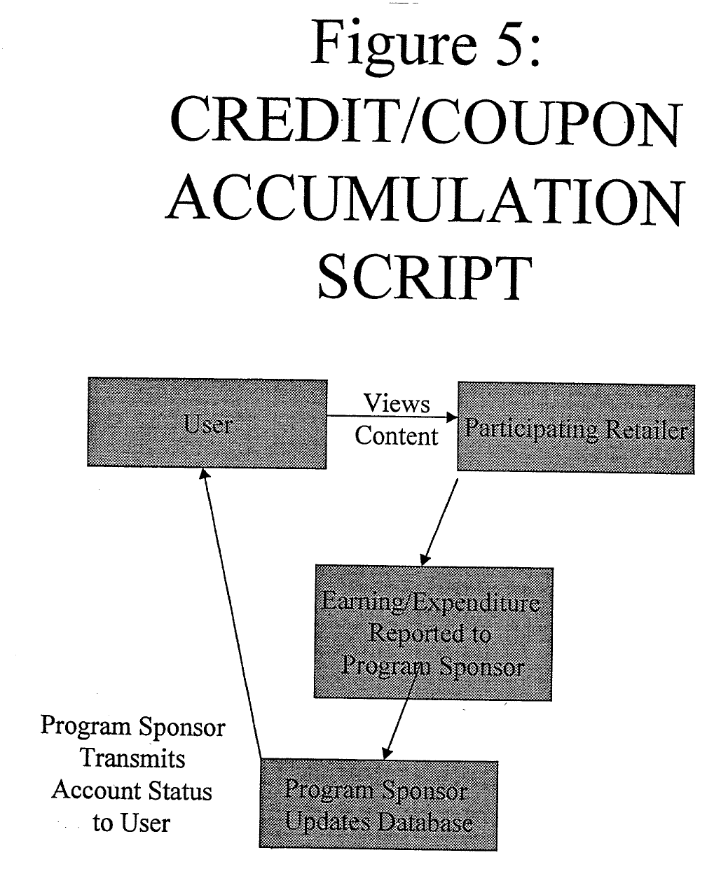

### DETAILED DESCRIPTION OF THE PREFERRED EMBODIMENTS

Preferred embodiments of the present invention will be described in detail hereinbelow, with reference to the drawings.

Although the following detailed description contains many specifics for the purpose of illustration, anyone of ordinary skill in the art will appreciate that many variations and alterations to the following description are with in the scope of the invention. Accordingly, the following preferred embodiment of the invention is se forth without any loss of generality to, and without imposing limitations upon, the claimed invention.

A preferred embodiment of the invention utilizes the following participants:

1) a Program Sponsor, who will be the entity who will maintain and operate the engine on one or more conventional web server machines with standard server software. The server or servers are connected to a computer network, such as the Internet, which enables the servers to communicate with Users, the public and Participating Retailers through other servers or Appliances. The server or servers operate to collect, process and store the necessary information, such as credits and/or coupons earned, which information is listed in a standard database format. In addition, the server or servers have the capability of communicating with others via the Internet, Intranets and other networks, standard email, instant messaging and other communication technologies.

In a preferred embodiment, the Program Sponsor contracts with merchants, advertisers and content providers willing to participate in the program. The Program Sponsor locates advertisers and advertising agencies that want people to view their ads and merchants (either on or off line, including content providers who want to sell or advertise their products or services or encourage viewing of their content). The function is to establish an additional method of Internet advertising for the viewing of fee based content and the sale of products and services. Participating Retailers are located using one of any number of well known marketing methods, including advertising, direct contact and agency contact.

2) Participating Retailers, advertiser's, merchants and content providers who will participate in the program by offering credits and/or coupons for the viewing of advertising or sampling of content or offering to sell their content, products or services in exchange for credits or coupons, and

3) Users who can access the engine via a PC or other device that accesses the Internet and World Wide Web (referred to as “Appliance” or “Appliances”) and that have signed up for the engine and the services it provides. The individual user actually signing up will be a Principal User, who will have full control over the account. If the Principal User represents a group (i.e., a household or family), the Principal User may also sign up “Affiliated Users” who will be named as such by the Principal User (either at sign up or later), and will have no rights other than to view their own sub account information. For purposes of the invention, the reference to “Users” shall apply to all Users, and the limiting preface will be used only when the limitation is relevant to the discussion.

An individual will become aware of the program in one of several ways. First of all, they may go directly to the Program Sponsor's website either unknowingly or be a non-link referral, such as by a friend or family member. Secondly, they may view advertising for the program, and go to the site by locating it in a well known fashion or via a hyperlink from another website. Thirdly, the individual may be visiting the site of a Participating Retailers, and be notified of the program either by viewing content regarding the program on the site or attempting to purchase a product or service or view fee based content. Under any of these scenarios, an individual would travel to the Program Sponsor's website, where they could learn more about the program and sign up as a User.

### The Sign On Script

In a preferred embodiment of the invention, individual person's access the Internet via an Appliance, and, by way of the means described above or any one of a number of other methods of contact, locate and travel to the Program Sponsor's website. Once at the Program Sponsor's website, the individual will click a hyperlink button or series of buttons linking to a page or pages with standard application type functions for the collection and submission of applications for membership. The individual will follow the steps set forth on these pages, which will include inserting information into blank spaces provided. In addition, if the individual is signing on as the representative of a group, the individual will make decisions regarding Affiliate Users, such as credit limits, restrictions regarding the type of viewable content that can earn credits or coupons and types of products or services that can be purchased. Once the individual inserts the information in the form, a button will take the individual to a page containing terms and conditions for participation in the program, and give the individual one or more opportunities to accept or reject those terms. If the terms are rejected, the completed form is emptied and the individual is returned to the Program Sponsor's home or other selected web page.

If the individual accepts the terms and conditions by clicking the appropriate button on the screen, the information is transmitted to the Program Sponsor to determine the individual's eligibility as a Principal User based upon the information provided. If the individual is found not eligible, they are notified, and may be given a chance to reapply. If the individual (who will become the Principal User) is accepted, all Affiliate Users are also accepted, and the information provided is used to establish an account for the Principal User and sub accounts for each Affiliated User, if any. The new Principal User will be directed to a web page or pages orienting them to the program, and providing notice of special offers and/or incentives to participate in the program. Affiliate Users will be presented with the same display or displays when they first access the Program. The Program Sponsor may permit a standard deposit of money by credit card or other form of payment to establish a credit balance. Instead of, or in addition to accepting money to establish a credit balance, the Program Sponsor may also grant, in the form of an incentive, a specific number of credits or specific coupons as a beginning balance.

### The User Operation Script

Once a Principal User has established an account, the User can access the status of their individual account in one of two ways.

In the preferred embodiment, the user will access the Internet through an Appliance (e.g., PC), which will have Program software on it which will contain the necessary executable files to display an account Status Bar (the “Status Bar”) upon entering any preconfigured sequence of non conflicting keys, or loading it through the desktop or similar feature of the Appliance being used by the User. The Status Bar is a bar or similarly elongated object that appears to cover the bottom, top or either side portion of the screen, with the remainder of the screen reserved for viewing content. The Status Bar, when activated by the User, sits on top of other content being viewed and will have superimposed on it logos, numbers, words, icons, symbols, or any combination thereof which indicate information needed to participate in the program, such as the identity of the Program Sponsor, the Username of the currently logged on User and the credit account balance. In addition, an indicator will be visible showing the presence of coupons in the account and if any of those coupons are time expired (meaning that the validity of the coupon expires after a certain period of time or certain date). In addition, the Status Bar will contain a hyper link to a standard website maintained by the Program Sponsor, which site will contain a listing of all Participating Retailers, what User involvement they require, and what they offer in the way of credits or coupons for that involvement. The location of the Status Bar can be moved to the top or to one or the other sides Appliance screen, as selected by the User, using the Appliance's pointing device (similar to moving the Windows TM Taskbar). The appearance, or “skin” of the Status Bar may also be modified by the User, who may select one of any number of pre designed Status Bar skins provided with the engine, or modify any one of the pre designed Status Bars into a customized Status Bar. The user may either temporarily hide or close out the Status Bar at any time by use of the Appliance's pointing device or entering a pre-selected sequence of keys from the computer keyboard.

In one embodiment, the status bar displays the current amount of credits/coupons of the User, by way of a game-like display (e.g., similar to many types of video games, such as those of Sony PLAYSTATION or SUPERNINTENDO, where a User's arsenal of ammunition is shown as a stack of ammunition on a portion of the display). For example, the number of credits/coupons currently available for use by the User may be shown as Dollar-Bill Icons that are stacked together to form a pile of Dollar Bill Icons, where each Icon may be worth 1 credit or 1 coupon, for example. As the user views content by cashing in his/her credits or coupons, the stack of Dollar Bills on the status bar starts to drop, based on the credit/coupon cost. For example, if it costs 1 coupon to watch 30 minutes of a pay-per-view movie, as the User is watching the pay-per-view movie, the stack of Dollar Bills displayed on the Statur Bar portion of the User's display will drop by 1 Dollar Bill every 30 minutes. Similarly, as a User is accumulating credits or coupons, such as by watching targeted advertising or by obtaining credits/coupons by making an e-commerce purchase, the Credit/Coupon Icons will increase on the display to reflect the current amount of credits/coupons available for use by the User.

In another embodiment of the invention, the User can also access their individual Account Information in a Detailed Account Status mode (Fg-4). To access the Detailed Account Status mode, the User may either use the Appliance's pointing device to “click” on the appropriate button that activates a hyperlink on the Status Bar or access the Detailed Account Status mode via the Program Sponsor's website, also by way of a button and hyperlink.

The Detailed Account Status mode provides the User with an opportunity to view all account data regarding that User, including the applicable charge limits, credit and coupon accumulation, coupon details and accumulation history resulting from that Users involvement in a site. Using this method and the password established at sign up, the Principal User can not only access all information regarding the Principal Users account, but also all information regarding each individual Affiliate Users' account or, in the alternative, accumulated information regarding all accounts. The Principal User can access account usage information which discloses, among other things, the websites visited by all Users, the credits and coupons accumulated by a User, and a record of purchases by the Principal user and each affiliated User. In addition, the Principal User can change any of the information provided in the sign up procedure.

Once a Principal User has established an account, a User can access the Status Bar for the purpose of viewing content and accumulating credits and coupons. In order to accumulate credits or coupons, the User either views content or make purchases of products of services from Participating Retailers. In the preferred embodiment, the accumulation of credits or coupons, and the purchase of goods or services with credits or coupons, is not allowed while the Status Bar is hidden or closed. In the present invention, the Program Sponsor has access to a memory storing a database of Participating Retailers, which can be accessed by “clicking” the appropriate button and activating a hyperlink on the Status Bar or from other web pages sponsored by the Program Sponsor. This database will organize and show details regarding each Participating Retailer, including but not limited to their name, product, service or content class or type, the level or levels of involvement required of Users, and the number of credits and/or coupons that can be accumulated in exchange for that involvement. Users may go directly to a Participating Retailer's website via a hyperlink provided in the database, in which case it will load and appear in the content portion of the screen.

The User may also connect with Participating Retailers by knowingly going directly to a site sponsored by a Participating Retailers, or by unknowingly going to a site sponsored by a Participating Retailers. In an embodiment, the website of each Participating Retailers would, upon loading, alert the software residing on the Appliance that the site being viewed is a Participating S Retailer, and provide the User with a link to that sites' policy for the distribution of credits or coupons in exchange for defined levels of User involvement or to the Program sponsor's database of Participating Retailers. The User could agree to become involved in the Participating Retailer's site to any level allowed, and accumulate credits or coupons for such involvement, or the User could refuse to become involved and leave that specific website and move on to another website or close the Status Bar and leave the program altogether.

The involvement of Users may extend to off-line activities, which may range from the printing out and mailing in of coupons, off-line use of credits for the purchase of products or services, to a User's physical involvement in off-line activities such as attendance at promotional events or taking a vehicle test drive. Once a User completes the involvement, the Participating Retailer advises the Program Sponsor of the involvement and the number of credits/coupons the User has earned from that involvement. The User's digital account is credited in the same manner as an on-line transaction.

### The Credit Accumulation Script

Once the User has decided to accept the terms of viewing a Participating Retailers site and to become involved in that site for the purpose of accumulating credits or coupons, the User follows that sites' instructions on what content to view and how to view it. As the User fulfills those instructions, the User accumulates the number of credits and/or coupons required by the Participating Retailers terms. The Program Sponsor polices the enforcement of both the Participating Retailers and Program Sponsor's rules.

The Participating Retailers, using standard website monitoring and reporting software and a server or servers, operated and maintained by the Participating Retailers to perform these functions, collects information regarding the Users involvement in the site. This information includes but is not limited to, a preselected manner of identifying the User, verification of the Users involvement that makes the User eligible for the accumulation of credits and/or coupons, and the number of credits and/or type of coupons the User is eligible to accumulate as a result of that involvement. Simultaneously with collection and confirmation of completion of a User's specific level of involvement, or upon the User exiting the Participating Retailers site, the information regarding the involvement and identifying the Participating Retailer is transferred to the Program Sponsor's server or servers and database software.

The Program Sponsor's server or servers receives the information, updating the database to reflect the accumulation. Assuming that the Status Bar is still open, the update will automatically change the content of the Status Bar and Detailed Account to reflect the credits and/or coupons accumulated by the involvement. That information, when registered in the program Sponsor's database, automatically updates the User's account, and that information is immediately sent to the User's computer to be reflected in the account status screen.

During the process of reflecting the accumulation in the Status Bar, the User may receive additional advertising or messaging initiated by the Participating Retailers the User is involved with, or other advertising or messaging initiated by the Program Sponsor regarding other opportunities to accumulate or spend credits or coupons. The additional communication may appear in the space reserved on the Status Bar, or may appear as a box or flash on the content portion of the screen.

### The Participating Retailers Script

The Participating Retailers will be responsible for providing the content to be viewed or involvement of the User, registering the presence of the User at the Participating Retailer's site or physical location, confirming to the Program Sponsor the Users completion of a specific stage of involvement and entitlement to credits or coupons and/or the expenditure of credits or coupons for the purchase of products or services. These functions, when related to on line activities, can be accomplished using standard web monitoring and reporting software and a server or servers owned, operated and maintained the Participating Retailers.

In an embodiment, Users receive credits for involvement or expend credits for purchases that does not require a computer. For instance, retailers may give credits for visitors to a car dealership, a new home development, or the off-line purchase of a product or service. The credits afforded for off line involvement would be substantially higher than on line, and again will be based on the level of involvement (i.e. the visit to a car dealership gets fewer credits than taking a test drive of a new vehicle).

Participating Retailer's may provide credits and/or coupons to Users for off-line activities, which may range from the printing out and mailing in of coupons, off-line use of credits for the purchase of products or services, to a User's physical involvement in off-line activities such as attendance at promotional events or taking a vehicle test drive.

In connection with off line User involvement in a Participating Retailer's off line advertising and promotional activities, Participating Retailers access a particular section of the Program Sponsor's website reserved for participating Retailers. That site allows a Participating Retailer to report earned or expended credits and coupons. This is done using a standard User Interface accessed by standard password protected Internet software known to anyone skilled in the art. The Participating Retailer reports the off-line earning or expenditure of credits and/or coupons and identifies the User by their User name and password. The earnings or expenditure of credits and/or coupons is verified and the User's account is immediately credited or debited, as appropriate, using the same methods and procedures as an on-line transaction. In addition, the Participating Retailer's account with the Program Sponsor is also credited or debited, as appropriate, using the same methods and procedures as an on-line transaction.

In an embodiment of the invention, the terms of the interaction between the Participating Retailers and User are established between the Program Sponsor and Participating Retailers. The extent and type of the User's involvement in the Participating Retailer's advertising and promotional activities is not part of the invention, that being left to the agreement of those parties. As it affects the Program Sponsor, that interaction is limited to directing the User to the Participating Retailer's website or physical location, accepting confirmation of the User's completion of the involvement, and crediting the User with credits an/or coupons as agreed to between the Program Sponsor and Participating Retailers.

While the present invention has been described with respect to the preferred embodiments, other types of configurations may be possible, while remaining within the spirit and scope of the present invention, as exemplified by the claims.

What is claimed is:

1. A method of operating a monetary exchange through a client server software engine, compising:
allowing advertisers and/or participating retailers to promote products and services to targeted consumers determined by profiling.

2. A method of operating a monetary exchange according to claim 1, further comprising:
providing credits and/or coupons through the monetary exchange to at least one consumer as an inducement to viewing advertising or content or participating in advertising or promotional activities.

3. A method of operating a monetary exchange according to claim 2, further comprising:
providing credits and/or coupons through the monetary exchange to at least one consumer as an inducement to viewing advertising or content or participating in advertising or promotional activities.

4. A method of operating a monetary exchange according to claim 3, further comprising:
permitting the advertisers and/or the participating retailers to award credits to Users for involvement in off line advertising and promotion activities

5. A method of operating a monetary exchange according to claim 4, further comprising:
allowing the at least one consumer to spend and/or exchange the credits and/or coupons for content and for selected e-commerce transactions.

6. A method of operating a monetary exchange according to claim 5, further comprising:
allowing the at least one consumer to establish an on-line account for purpose of accumulating and exchanging credits and/or coupons for content and for selected e-commerce transactions.

7. A method of operationg a monetary exchange according to claim 6, further comprising:
allowing the advertisers and/or the participating retailers to scale credit use with quality of service with which the content is delivered to the at least one consumer.

8. A method of operating a monetary exchange according to claim 7, further comprising:
providing, on a display of a machine operated by the at least one consumer, current credit and/or coupon account balances of the at least one consumer.

9. A method of operating a monetary exchange according to claim 8, further comprising:
billing the at least one consumer periodically for credits used in excess of credits earned.

10. A method of operating a monetary exchange according to claim 9, further comprising:
assigning priority levels to each of the at least one consumer in a group of consumers, so that a higher priority consumer is capable of limiting a lower priority consumer's credit and/or coupon accumulation and use rights, wherein the higher priority consumer and the lower priority consumer are in a same group.

11. A method of operating a monetary exchange according to claim 10, further comprising:
tracking credits and/or coupons earned by each member of a group of consumers.

12. A method of operating a monetary exchange according to claim 11, wherein the group of consumers correspond to family members living in a same household.

13. A method of operating a monetary exchange according to claim 10, further comprising:
tracking credits and/or coupons earned by each member of a group of consumers, to provide a total amount of credits and/or coupons earned by the group.

14. A method of operating a monetary exchange according to claim 11, further comprising:
allowing each member in the group of consumers an ability to share, exchange, or barter credits between other members in the group of consumers.

15. A method of operating a monetary exchange according to claim 1, further comprising:
maintaining an on-line account for said at least one consumer, the on-line account providing information regarding accumlated and exchanged credits and/or coupons for the at least one consumer.

16. A method of providing information concerning a monetary exchange method operable of the Internet, comprising:
displaying, on a display, information that a consumer can utilize in the monetary exchange method,
wherein the information relates to an amount of coupons and/or credits currently available for use by the consumer, and
wherein the coupons and/or credits may be used by the consumer to conduct e-commerce transactions on the Internet or to obtain audio or video content from the Internet.

17. A method of providing information according to claim 16, wherein the information is displayed in a game format.

18. A method of providing information according to claim 16, wherein the information is displayed on top of content that otherwise would fill the display in its entirety if the information was not present on the display.

19. A method of providing information according to claim 16, wherein the game format is modifiable by the consumer, with regards to location on the display and appearance on the display.

20. A method of providing information according to claim 16, further comprising:
displaying the information on a status bar, wherein the information identifies a program sponsor.

22. A method of providing informatoin according to claim 16, further comprising:
displaying the information on a status bar, wherein the information is a current credit account balance of a remaining amount of credits and/or coupons of the consumer.

23. A method of providing information according to claim 16, further comprising:
displaying targeted advertising initiated by a program sponsor or a participating retailer.

24. A method of providing information according to claim 23, wherein the targeted advertising is provided by the program sponsor or the participating retailer,

25. A method of providing information according to claim 24, wherein the targeted advertising is content-specific advertising that is displayed on the status bar.

26. A method of providing information according to claim 23, wherein the targeted advertising is displayed on a content portion of the display which displays the content to the consumer.

27. A method of providing information according to claim 26, wherein the targeted advertising is or content-specific advertising geographic-location-specific advertising.

28. A method of providing information according to claim 20, wherein the display of the information is continuously updated to reflect accumulation and/or use of credits and/or coupons by the consumer.

29. A method of providing information according to claim 23, wherein the targeted advertising is displayed as being superimposed on a content portion of the display which displays the content to the consumer.
